(19) United States
(12) Patent Application Publication
(10) Pub. No.: US 2024/0053038 A1
(43) Pub. Date: Feb. 15, 2024

(54) DETERMINING EFFECTS OF A HVAC UNIT ON AN ENVIRONMENT

(71) Applicant: SENSIBO LTD., Ramat Gan (IL)

(72) Inventors: Omer ENBAR, Ramat Gan (IL); Ran ROTH, Ramat Gan (IL); Gilad GERSHTEIN, Ramat Gan (IL)

(21) Appl. No.: 18/259,664

(22) PCT Filed: Jan. 9, 2022
(86) PCT No.: PCT/IL2022/050028

§ 371 Date: Jun. 28, 2023

Related U.S. Application Data
(60) Provisional application No. 63/137,166, filed on Jan. 14, 2021.

(51) Int. Cl. F24F 11/48; F24F 11/52

(52) U.S. Cl. CPC F24F 11/48; F24F 11/52; F24F 2110/10

(57) ABSTRACT

A method, apparatus, and product, comprising performing, in an environment where a Heating, Ventilation, or Air Conditioning (HVAC) unit is deployed, the steps of: performing a testing phase that is configured to test an influence of the HVAC unit on a temperature of the environment, by: performing a testing sequence that comprises a sequence of two or more actions, wherein an action comprises instructing the HVAC unit to change its target temperature, and performing measurements of effects of the actions on the temperature of the environment; based on the testing phase, generating a temperature profile that indicates the influence of the HVAC unit on the temperature of the environment; and based on the temperature profile, generating a recommendation for a utilization of the HVAC unit.

### CROSS-REFERENCE TO RELATED APPLICATION

This application claims the benefit of Provisional Patent Application No. 63/137,166, titled “A System And Method For A Continuous And Periodic Energy Efficiency And Equipment Health Check For A Cooling System” filed Jan. 14, 2021, which is hereby incorporated by reference in its entirety without giving rise to disavowment.

### TECHNICAL FIELD

The present disclosure relates to the operating of Heating, Ventilation, or Air Conditioning (HVAC) units in general, and to determining effects of a HVAC unit on an environment, in particular.

### BACKGROUND

Heating, Ventilation, or Air Conditioning (HVAC) systems constitute a significant factor in the energy consumption of residential as well as commercial consumers.

Existing HVAC system specifications usually state the expected cooling properties, heating properties, and power consumption of the units. However, the actual properties of each unit may be significantly different due to one or more of a multiplicity of factors, such as installation location or configuration, frequency of use, target temperature, fan settings, local weather which may include outside temperature or humidity conditions, room or space size, room occupancy, or others.

### BRIEF SUMMARY

One exemplary embodiment of the disclosed subject matter is a method operated in an environment where a Heating, Ventilation, or Air Conditioning (HVAC) unit is deployed, the method comprising: performing a testing phase, wherein the testing phase is configured to test an influence of the HVAC unit on a temperature of the environment, wherein the testing phase comprises: performing at least one testing sequence, wherein a testing sequence of the at least one testing sequence comprises a sequence of two or more actions, wherein at least one action of the two or more actions comprises instructing the HVAC unit to change its target temperature, and performing measurements of effects of the two or more actions on the temperature of the environment; based on the testing phase, generating a temperature profile, wherein the temperature profile indicates the influence of the HVAC unit on the temperature of the environment; and based on the temperature profile, generating a recommendation for a utilization of the HVAC unit.

Optionally, the method comprises obtaining one or more properties of the environment, wherein said generating the recommendation is based on the one or more properties of the environment.

Optionally, the one or more properties of the environment comprise: a location of the HVAC unit in the environment; a location of sensors used to obtain the measurements within the environment; a two-dimensional area of the environment; a three-dimensional volume of the environment; locations of each window in the environment or portion thereof; sizes of each window in the environment or portion thereof; locations of each door opening in the environment or portion thereof; sizes of each door opening in the environment or portion thereof; an indication of a cardinal direction with respect to the environment, or the like.

Optionally, the method comprises performing a comparison between the temperature profile and one or more additional temperature profiles, wherein the one or more additional temperature profiles comprise temperature profiles of multiple HVAC units in other environments having environment profiles that are within a similarity measurement threshold to an environment profile of the environment, wherein the environment profile of the environment is based on measurements of the one or more properties, the method further comprising determining based on said comparison an isolation level of the environment, a performance measurement of the HVAC unit, or the like.

Optionally, said obtaining comprises: presenting to a user via a graphical user interface a visual illustration of the environment; and receiving user instructions defining the one or more properties of the environment with respect to the visual illustration of the environment.

Optionally, the measurements are performed based on sensor readings from one or more sensors that are deployed in the environment, wherein at least one sensor of the one or more sensors is external to the HVAC unit.

Optionally, the sequence of two or more actions comprises an evacuation action, wherein the evacuation action is an instruction to vacate living subjects from the environment.

Optionally, the sequence of two or more actions comprises an action to adjust external influence on the environment, wherein the action to adjust external influence on the environment comprises an instruction that modifies a state of an object within the environment in order to affect external influence on the temperature within the environment.

Optionally, the environment comprises a room, wherein the action to affect the external influence on the environment comprises instructing to adjust a state of an opening of the room, wherein the opening is one of: a window, and a door.

Optionally, the method comprises selecting the at least one testing sequence from a set of multiple testing sequences, wherein the set of multiple testing sequences comprises an additional testing sequence that is not comprised in the at least one testing sequence, whereby not performing the additional testing sequence in the environment.

Optionally, selecting the at least one testing sequence is based on at least one of: one or more properties of the environment, and a time constraint indicated by a user of the HVAC unit.

Optionally, the temperature profile indicates at least one of: an effective minimum temperature that can be produced by the HVAC unit in the environment; an effective maximum temperature that can be produced by the HVAC unit in the environment; a rate of heat loss from the environment; and a rate of heat transfer to the environment.

Optionally, at least a portion of the two or more actions are performed automatically.

Optionally, the method comprises performing a comparison between the temperature profile and one or more additional temperature profiles, wherein the additional temperature profiles comprise previous temperature profiles that were generated for the HVAC unit, wherein the method comprises detecting a degradation of a functionality of the HVAC unit within the environment based on said comparison.

Optionally, the recommendation comprises a recommendation for adjusting at least one property of the environment.

Optionally, the testing sequence comprises: instructing to close openings of the environment; instructing to vacate living subjects from the environment; instructing the HVAC unit to provide a minimum temperature; and instructing the HVAC unit to provide a maximum temperature, wherein a first temperature of the environment is measured subsequently to instructing the HVAC unit to provide the minimum temperature, and a second temperature of the environment is measured subsequently to instructing the HVAC unit to provide the maximum temperature, whereby determining an effective minimum temperature that can be produced by the HVAC unit in the environment, and an effective maximum temperature that can be produced by the HVAC unit in the environment.

Another exemplary embodiment of the disclosed subject matter is an apparatus comprising a processor and coupled memory, said processor being adapted to perform, in an environment where a HVAC unit is deployed, the steps of: performing a testing phase, wherein the testing phase is configured to test an influence of the HVAC unit on a temperature of the environment, wherein the testing phase comprises: performing at least one testing sequence, wherein a testing sequence of the at least one testing sequence comprises a sequence of two or more actions, wherein at least one action of the two or more actions comprises instructing the HVAC unit to change its target temperature, and performing measurements of effects of the two or more actions on the temperature of the environment; based on the testing phase, generating a temperature profile, wherein the temperature profile indicates the influence of the HVAC unit on the temperature of the environment; and based on the temperature profile, generating a recommendation for a utilization of the HVAC unit.

Yet another exemplary embodiment of the disclosed subject matter is a computer program product comprising a non-transitory computer readable medium retaining program instructions, which program instructions when read by a processor, cause the processor to perform, in an environment where a HVAC unit is deployed, the steps of: performing a testing phase, wherein the testing phase is configured to test an influence of the HVAC unit on a temperature of the environment, wherein the testing phase comprises: performing at least one testing sequence, wherein a testing sequence of the at least one testing sequence comprises a sequence of two or more actions, wherein at least one action of the two or more actions comprises instructing the HVAC unit to change its target temperature, and performing measurements of effects of the two or more actions on the temperature of the environment; based on the testing phase, generating a temperature profile, wherein the temperature profile indicates the influence of the HVAC unit on the temperature of the environment; and based on the temperature profile, generating a recommendation for a utilization of the HVAC unit.

Yet another exemplary embodiment of the disclosed subject matter is a system comprising a processor and coupled memory, said processor being adapted to perform, in an environment where a HVAC unit is deployed, the steps of: performing a testing phase, wherein the testing phase is configured to test an influence of the HVAC unit on a temperature of the environment, wherein the testing phase comprises: performing at least one testing sequence, wherein a testing sequence of the at least one testing sequence comprises a sequence of two or more actions, wherein at least one action of the two or more actions comprises instructing the HVAC unit to change its target temperature, and performing measurements of effects of the two or more actions on the temperature of the environment; based on the testing phase, generating a temperature profile, wherein the temperature profile indicates the influence of the HVAC unit on the temperature of the environment; and based on the temperature profile, generating a recommendation for a utilization of the HVAC unit.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a schematic illustration of an exemplary environment in which the disclosed subject matter may be utilized, in accordance with some exemplary embodiments of the disclosed subject matter;

FIG. 2 shows a flowchart diagram of a method, in accordance with some exemplary embodiments of the disclosed subject matter;

FIG. 3 shows a flowchart diagram of a method, in accordance with some exemplary embodiments of the disclosed subject matter;

FIG. 4 shows an exemplary room model, in accordance with some exemplary embodiments of the disclosed subject matter; and

FIG. 5 shows a block diagram of an apparatus, in accordance with some exemplary embodiments of the disclosed subject matter.

### DETAILED DESCRIPTION

One technical problem dealt with by the disclosed subject matter is enhancing a utilization of a Heating, Ventilation, or Air Conditioning (HVAC) unit in a deployed room or environment (referred to hereinafter as ‘room’). In some cases, in contrast to some laboratory conditions, real-world conditions may adversely affect a performance of HVAC units. For example, thin walls in a room in which a HVAC unit is deployed may result with a high rate of heat loss, which may cause the HVAC unit to utilize more energy resources than HVAC units that are deployed in a room with thick walls, with unsatisfactory temperature results. In some cases, it may be desired to optimize an effect of a HVAC unit on the room.

Another technical problem dealt with by the disclosed subject matter is measuring an actual effectiveness of different settings of HVAC units, on a room in which the units are deployed. In some cases, a HVAC unit may be configured to obtain temperature-related instructions, in real time, such as via a display interface, via communication messages from a remote control, or the like, and attempt to implement the instructions. For example, a user may instruct an Air Conditioner (AC) to cool the room to a temperature of 19 degrees, e.g., via a remote control. In some cases, the HVAC unit may be configured to measure a temperature of the room using one or more sensors, and based thereon adapt a usage of components thereof such as its compressor, condenser, or the like, in order to reach the target temperature. In some cases, the instructions may not always be fulfilled precisely. For example, in case a window is open, and an outside temperature is high (e.g., above a threshold), a HVAC unit may not be able to decrease a temperature of the room to a target degree. As another example, the HVAC unit may affect only a small zone of the room that is adjacent thereto, and a sensor that is embedded within the HVAC unit may measure the target temperature in the zone, although the average temperature in the room may not comply with the target temperature. In some exemplary embodiments, it may be desired to measure an actual effect of deployed cooling and heating systems on the entire room.

Yet another technical problem dealt with by the disclosed subject matter is enabling to reduce resource consumptions of HVAC units, such as by reducing their power consumption without compromising on the effects of the HVAC units.

One technical solution provided by the disclosed subject matter includes testing an effect of a cooling system, a heating system, or the like, e.g., a HVAC unit, on a room or on any other space in which the HVAC unit is deployed. In some exemplary embodiments, HVAC units may refer to one or more air conditioners, heat pumps, furnaces, fans, heaters, or the like. In some exemplary embodiments, the HVAC units may be deployed and operated in a single room, in a space comprising adjacent rooms, in a house or apartment, in a public space, in an open space that is open to an external environment, or the like. In some exemplary embodiments, the testing of the effect may include configuring the HVAC unit in one or more configurations, settings, or the like, and performing measurements that measure the effect of the configurations on the environment. In some exemplary embodiments, the testing may be performed periodically, continuously, or the like. In some exemplary embodiments, identifying the effects of different configurations of the HVAC unit on the environment may enable to estimate a functionality level of the HVAC unit, a functionality level of other equipment, an energy efficiency of the HVAC unit, parameters that reduce or increase a performance of the HVAC unit, or the like.

In some exemplary embodiments, in order to determine the efficiency of cooling and heating systems and their effect on the room, the testing (referred to as a ‘testing phase’ or ‘periodic check’) may be performed in a controlled environment. In some exemplary embodiments, a controlled environment may refer to a space with regulated environmental factors, which may be isolated, at least partially, from external effects. For example, the testing phase may be performed in a controlled environment such as a sealed room that is isolated from an external environment, a room with a determined level of isolation, a room that is vacant of living subjects, or the like.

In some exemplary embodiments, the testing phase may be initiated and scheduled semi-automatically, automatically, manually, a combination thereof. or the like. In some cases, a user may be instructed to initiate a testing phase upon determining automatically that a testing phase has not been performed for a defined time frame, upon determining that a defined time frame has elapsed from the last testing phase, upon determining that an event of interest occurred (e.g., the room is vacant from living subjects), upon determining that a threshold was met, or the like. As another example, the testing phase may be initiated upon detecting that the environment conditions are adequate for the testing process. In some exemplary embodiments, the testing phase may be initiated and performed automatically without an assistance of a user, with partial assistance of a user, or the like.

In some exemplary embodiments, in order to obtain a controlled environment, the room in which the HVAC device is deployed may be turned into a controlled environment, e.g., by minimizing a rate of heat loss from the room to the external environment, controlling properties of the room, minimizing external influences, or the like. For example, each testing sequence of the testing phase may define an initial controlled state or layout of the room, and the initial state may be obtained using automatic means, manual means, or the like. In some exemplary embodiments, during the preparation of the room, cooled or heated spaces may be isolated, openings thereof may be sealed (e.g., using a window coverings) in order to minimize a heat loss from the room to the external environment, openings may be sealed in order to minimize a heat transfer from the external environment to the room, or the like. In some exemplary embodiments, room openings may refer to any area of the room that can be adjusted to conduct less heat, to increase an isolation level of the room, or the like. For example, a glass wall that cannot be opened but can be covered with a shutter to prevent heat transfer into the room, may be considered a room opening. In some cases, room openings may be opened in a controlled manner, such as in order to detect a specific influence of an external feature on the room.

In some exemplary embodiments, after preparing the room and reaching the initial state, the room may be considered a controlled environment. In some exemplary embodiments, the room may be brought to the initial state as part of a testing phase, or independently thereof such as prior thereof, or the like. In some exemplary embodiments, during the testing phase, one or more predefined testing sequences may be generated, implemented, or the like. In some exemplary embodiments, the testing sequences may comprise two or more actions, commands, sequences of commands, or the like. In some cases, the testing phase may be performed in an uncontrolled environment, such as during a regular operation of the HVAC unit, however such testing may not be as reliable.

In some exemplary embodiments, the testing sequences may be implemented by generating one or more instructions, and sending the instructions to a human operator, to a receiver of a HVAC unit, or the like. For example, the testing sequences may be implemented by sending control signals to the HVAC unit. As another example, a testing sequence may instruct the HVAC device to heat the room to a first target temperature, and then to cool down the room to a second target temperature. In some exemplary embodiments, the actions may be implemented automatically, such as by sending control signals to an AC device, sending control signals to devices that control openings of the room, or the like. In some exemplary embodiments, the actions may be implemented manually, such as by instructing a user to open a window and then close it, e.g., in case the window cannot be controlled automatically.

In some exemplary embodiments, effects of the testing sequences of a temperature of the room may be measured by one or more sensors such as temperature sensors that are deployed in the room and are external to the HVAC unit. In some exemplary embodiments, during an implementation of one or more instructions of a testing sequence, sensor readings and measurements may be logged, recorded, stored, or the like, e.g., by one or more sensors deployed in or adjacent to the room. In some cases, sensor readings and measurements may be logged at any other time frame, e.g., after an implementation of one or more instructions of a testing sequence. For example, a testing sequence may instruct an AC to increase its temperature to a maximum level, to decrease its temperature to a minimum level, or the like, and the temperature after each instruction may be measured by sensors. As another example, a testing sequence may generate an evacuation action that instructs a user to vacate living subjects from the environment, e.g., in order to reach the initial state of the room. As another example, a testing sequence may instruct a user to modify a property of the room during the testing, e.g., open a window 30 minutes after the testing has started.

In some exemplary embodiments, measurements of a temperature in the room may be performed upon each action, event, or instruction signal of the testing sequence, subsequently thereto, or the like. In some exemplary embodiments, measurements may be made subsequently to each action, continuously after each action, periodically after each action, or the like. In some exemplary embodiments, in case the testing phase includes instructing to perform actions such as opening a door, closing a door, opening a window, or the like, an effect of each action on the room's temperature may be measured and classified according to a measured temperature change of the room that is associated with the instructed action, e.g., an effect that is obtained in an associated time frame to the instruction. For example, opening a door may be determined to decrease an effectiveness of an AC by 30%, or any other percentage, based on sensor measurements that are obtained after opening the door and compared to sensor measurements that are obtained prior to opening the door.

In some exemplary embodiments, the testing sequences may be determined based on one or more properties of the room, the HVAC unit, or the like. In some exemplary embodiments, the testing sequences may be obtained, e.g., from a server, a third party device, or the like, and one or more sequences that are obtained may be selected to be implemented in the room, e.g., based on one or more properties of the room, the HVAC unit, or the like. In some cases, a same set of one or more testing sequences may be selected for all rooms, environments, or the like. In some cases, different testing sequences may be selected for different rooms.

In some exemplary embodiments, based on the testing phase, a temperature profile (also referred to as ‘temperature report’) indicating temperature properties of the room, effects of the HVAC device on the room, or the like, may be built, generated, created, determined, or the like. In some exemplary embodiments, the temperature profile may be determined based on measured effects of testing sequences on the room, an environment profile indicating properties of the room, a device profile indicating properties of the HVAC device, a combined model or profile indicating properties of both the room and the HVAC device, or the like. In some exemplary embodiments, the temperature profile may be generated for a current installation or deployment of the HVAC device within the room, for a current deployment of sensors within the room, for a current setup of the room, or the like.

In some exemplary embodiments, the temperature profile may be generated to indicate temperature properties of the room with respect to the HVAC unit, energy properties of the room, or the like, such as a measured rate of heat loss from the environment, a measured rate of heat transfer to the environment, a minimum and maximum temperature that can be reached by the HVAC unit in the room, an isolation level of the room, or the like. In some exemplary embodiments, when cooling down a room, the temperature of the room may first drop at a high rate, and then at a lower rate. The rate of cooling may slow down until reaching a point of balance of the room (e.g., a point in which the temperature moves up and down continuously, stays stable, or the like). Similarly, when warming up a room, the temperature of the room may first increase at a high rate, and then at a lower rate until reaching a point of balance. In some exemplary embodiments, the minimum and maximum temperatures of the room may correspond to the points of balance of the room.

In some exemplary embodiments, one or more derivations or insights may be determined from the temperature profile. For example, a recommendation to modify settings of the room, or modify settings of the HVAC unit, may be determined based on the temperature profile. In some exemplary embodiments, a recommendation of an adjustment may be determined based on a comparison of the temperature profile to other temperature profiles of other units, to manufacturer specifications of the system, to a baseline of the same HVAC unit, to regular usage parameters of the HVAC unit, or the like. For example, based on a comparison of the temperature profile of an HVAC unit that is deployed in a room with a first value of a property, e.g., a thin wall thickness, to temperature profiles of HVAC units of the same model that are deployed in rooms with a second value of the property, e.g., a thicker wall thickness, a recommendation to thicken the walls of the room may be generated.

In some exemplary embodiments, the temperature report may be compared to temperature reports of other HVAC units, e.g., belonging to different users with similar or different conditions. In some exemplary embodiments, temperature reports may be compared to previous temperature reports of the same equipment type (e.g., the same HVAC unit type or model), to other HVAC units that have same or similar properties, to other HVAC units that have different properties, to other HVAC units that are deployed in a room with similar or different environment profiles, a combination thereof, or the like. In some cases, a temperature report of an AC may be compared to temperature reports of ACs of a same model that are deployed in a similar room, e.g., having an environment profile that corresponds at least partially to the environment profile of the AC. For example, a temperature report of an AC may be compared to temperature reports of ACs that are deployed in rooms with same or similar (e.g., the difference being below a threshold) room sizes, such as in order to isolate properties of the AC from the room properties and identify differences between the functioning of the current AC to other ACs. In some exemplary embodiments, time series analysis may be made, e.g., by comparing temperature reports that are made during one or more time-based period types such as during one or more seasons, storm types, holidays, or the like, to temperature reports that were made at a previous time periods of the same type. For example, an effectiveness of an AC during a summer period may be compared to the effectiveness of the same AC or AC type during previous summers.

In some exemplary embodiments, temperature reports may be compared with manufacturer system specifications of the HVAC unit that were specified by the manufacturer of the HVAC, thereby enabling to determine a difference between the intended functionality of the HVAC unit and the effective functionality of the HVAC unit in the room. In some exemplary embodiments, the temperature profiles and/or the detected differences from the manufacturer specifications, may be reported to one or more technicians or manufacturers of the equipment, such as in order to enable them to assess the effects of deployment environments on their equipment. For example, upon identifying that a difference from the manufacturer specifications is unique or overpasses a threshold, the detected differences may be reported.

In some exemplary embodiments, an initial temperature profile of an HVAC unit in a room, or any other temperature profile, may be used as a baseline profile, to which later temperature profiles of the HVAC unit in the room may be compared to extract insights, generate recommendations, or the like. For example, decreased performance rates compared to the baseline profile may enable the detection of a degradation of the performance of the HVAC unit over time. In some exemplary embodiments, the baseline profile may be used by one or more recommendation systems to recommend whether the equipment (e.g., the HVAC unit or portions thereof) should be replaced or fixed, in what way, whether filters of the unit should be cleaned, whether maintenance steps should be conducted, whether room settings should be changed, or the like.

In some exemplary embodiments, during the day to day operation of the equipment, user instructions to the HVAC unit may be monitored, and measurements from sensors deployed within the room may be logged, to thereby obtain records of the usage, detect sub-optimal settings, or the like. In some exemplary embodiments, the temperature profile may enable to calculate, during regular usage of the HVAC unit, whether the regular usage is optimal or sub-optimal. In some exemplary embodiments, the temperature profile may enable detect suboptimal usage scenarios. For example, based on the temperature profile, a usage or settings of the HVAC unit may be determined to be suboptimal. As another example, based on the temperature profile, a state of the rooms' openings may be determined to be sub-optimal, and a recommendation to change the state may be generated. As another example, user instructions to the HVAC unit may be determined to utilize resources in a suboptimal manner, such as by setting an unfeasible temperature that is below the minimal effective temperature of the HVAC unit in the room, and a recommendation may be generated to increase the instructed temperature. In some cases, a usage history of the normal operation of the HVAC unit may be processed and utilized to enrich a temperature profile, add information thereto, or the like. For example, the usage history may be used to assess the efficiency and health of the equipment, to detect anomalies, to detect degradation of the equipment, to detect changes in the room properties, to determine when a next testing phase should be performed, or the like. In some exemplary embodiments, one or more recommendations to change the usage of the HVAC unit, the layout of the room, or the like, may be generated based on the usage history, based on the temperature profile, or the like.

In some exemplary embodiments, one or more recommendations, reports, alerts, notifications, messages, or any other reporting methods may be generated. In some exemplary embodiments, the reports or recommendations may be made based on the comparisons, the usage history, the manufacturer specifications, or the like. In some exemplary embodiments, a recommendation may be determined based on insights that are derived from the comparisons such as detected problems, detected changes over time, detected anomalies, or the like. In some exemplary embodiments, a generated report indicating the temperature profile, detected differences from other temperature profiles, detected differences from the manufacturer specifications, differences from the usage history, or any other detected differences or derivations thereof, may be reported via a communication medium such as an online communication platform. The reporting may be initiated automatically in real-time, manually such as upon obtaining user instructions, upon identifying that a difference from other profiles or specifications is unique or overpasses a threshold, or the like.

In some exemplary embodiments, recommendations and reports may be presented on a screen of the HVAC unit, a screen of another computing device (e.g., a control device), a screen of a remote control of the HVAC unit, a screen of a user device such as a smartphone, or the like. Any other reporting methods may be utilized to present the recommendation to one or more parties. In some exemplary embodiments, the recommendation may be presented to one or more parties such as the user, a technician, a manufacturer of the equipment, a renovating entity, or any other party.

For example, in case the temperature profile indicates that a minimum temperature that the HVAC unit can reach in the room is 20 degrees, and the user sets the HVAC unit to 18 degrees, the user may be alerted to increase the setting to 20 degrees, thereby saving energy and/or electricity resources without changing the resulting temperature. As another example, in case of detecting a degradation of the HVAC unit, the user may be alerted. As another example, in case a state of a window is determined to be suboptimal, the recommendation may indicate to change the state of the window in order to increase the efficiency of the HVAC unit, e.g., via an alert. In some exemplary embodiments, in addition to or instead of generating a recommendation, one or more insight, parameters, current states, or the like, may be determined. For example, the user may be provided with an estimated energy cost of a usage of the HVAC unit, derivations thereof, an expected resulting temperature from the usage, or the like.

One technical effect provided by the disclosed subject matter is providing a temperature profile indicating measured effects of using a HVAC unit in a room. Based on the temperature profile, insights regarding the HVAC unit and/or the room may be determined, and recommendations to adjust settings of the HVAC unit, the room, or the like, may be determined.

Another technical effect provided by the disclosed subject matter is enabling to track changes of the temperature profile over time, thereby enabling to identify degradations of the HVAC unit, changes to the room properties (e.g., a width of the walls, changes to the windows, or the like), or the like. In some exemplary embodiments, tracking the changes in the environment and temperature behavior may enable the detection of issues that need to be fixed, detect anomalies, determine recommendations for adjusting a setting of the HVAC unit or a room setting in a normal usage of the HVAC unit, or the like.

Yet another technical effect provided by the disclosed subject matter is enabling to detect, during a regular usage of the HVAC unit, a suboptimal utilization of the HVAC unit in the room. In some exemplary embodiments, recommendations for changing a usage or setting of the HVAC unit within the room may be determined based thereon.

Yet another technical effect provided by the disclosed subject matter is enabling to diagnose an HVAC unit without necessarily having access to internal features thereof. For example, the HVAC unit may be provided by a first vendor, and the disclosed subject matter may be provided by a second different vendor that has no access to internal data of the HVAC unit. In some exemplary embodiments, the disclosed subject matter enables to generate automatic diagnostics of the effects of the HVAC unit on the room, and compare results to other HVAC units, and thereby extract insights such as whether the HVAC unit functions properly, without having access to internal data of the unit, components thereof, or the like.

Yet another technical effect provided by the disclosed subject matter is enabling to test the temperature effects of HVAC units on an environment with a relatively high precision, such as due to using a controlled environment for the testing phase with defined and limited external influence.

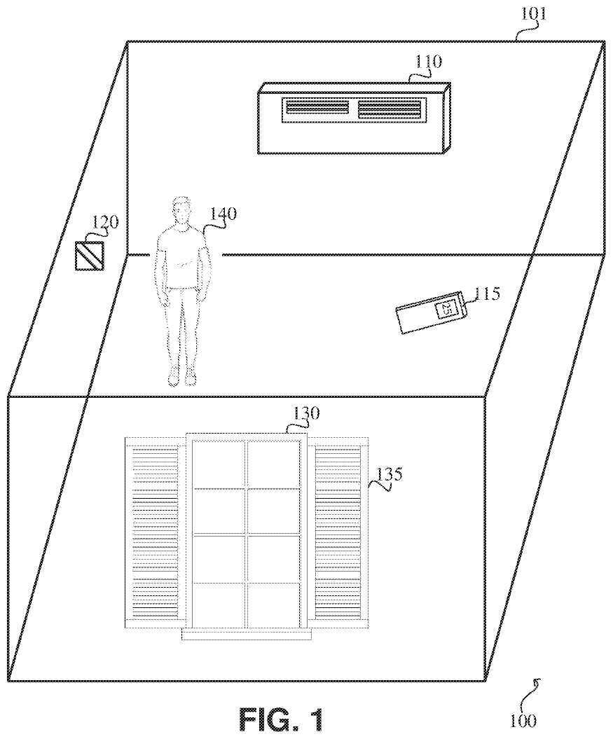

Referring now to FIG. 1, showing a schematic illustration of an environment in which the disclosed subject matter may be utilized, in accordance with some exemplary embodiments of the disclosed subject matter.

In some exemplary embodiments, Environment 100 may comprise a Room 101, in which one or more cooling and/or heating devices such as HVAC units are deployed. In some cases, Room 101 may comprise an AC such as HVAC Unit 110. In other cases (not illustrated), any other number and types of HVAC units may be deployed within Room 101. In some exemplary embodiments, HVAC Unit 110 may be installed at any location of Room 101. HVAC Unit 110 may be connected to a compressor unit (not shown) or another operative unit which is typically installed externally to room 101. HVAC Unit 110 may comprise one or more modes, such as a cooling or heating mode utilizing the compressor unit, a fan mode utilizing an internal fan, a combined mode utilizing a combination of the compressor unit and the internal fan, or the like. HVAC Unit 110 may comprise a communication receiver, such as an Infrared (IR) receiver, Radio Frequency (RF) receiver, an ultrasonic receiver, or the like. In some exemplary embodiments, HVAC Unit 110 may control the compressor based on measurements from one or more sensors such as a temperature sensor, a humidity sensor, or the like, which may be embedded therein, in Remote Control 115, or the like.

Room 101 may comprise Remote Control 115. In some cases, Remote Control may comprise one or more embedded sensors, such as a temperature sensor, a humidity sensor, or the like. Remote Control 115 may have controls thereon to enable a User 140 to manually submit commands to the HVAC Unit 110, such as commanding HVAC Unit 110 to turn on, to set a target temperature, to set a timer, or the like. Remote Control 115 may submit the commands via one or more signals using an IR transmitter, an RF transmitter, or the like. In some exemplary embodiments, in response to control signals from Remote Control 115, HVAC Unit 110 may determine, for example, by a controller thereof, whether and how to operate HVAC Unit 110 or components thereof. For example, based on the control signals from Remote Control 115 indicating a temperature measured at Remote Control 115, HVAC Unit 110 may determine whether or not to activate the compressor. According to this example, in case a target temperature is less than the measured temperature at Remote Control 115, HVAC Unit 110 may determine to activate the compressor.

In some exemplary embodiments, Room 101 may comprise one or more sensors, which may be external to Remote Control 115, to HVAC Unit 110, or the like. In some exemplary embodiments, the sensors may comprise independent sensors that can be deployed and installed independently, and/or embedded sensors. For example, an independent sensor may comprise Sensor 120, which may be configured to measure temperature or humidity level across the room. In some exemplary embodiments, Sensor may be different and external from HVAC Unit 110 or any other heating or cooling system that is used in Room 101. In some exemplary embodiments, the sensors of Room may comprise temperature sensors that are configured to measure a temperature in one or more heights, sides, areas, or the like, of Room 101, a proximity sensor that is configured to identify whether the room is vacant of living subjects, or the like. In some exemplary embodiments, Environment 100 may comprise one or more sensors external to Room 101 (not illustrated), such as sensors for measuring an outside temperature, sensors for measuring an outside humidity level, communication sensors or devices that obtain localized weather data from third party servers, or the like.

In some exemplary embodiments, the locations of deployment of the sensors, including Sensor 120, with respect to Room 101, may affect an accuracy of a measured temperature of Room 101. In order to obtain a measurement with a high accuracy that is correct for all or most portions of Room 101, sensors may be deployed in key locations at various positions, heights, areas, or the like, of Room 101. For example, sensors may be deployed at one or more air vents of HVAC Unit 110 that let the air in Room 101 enter and exit air ducts, at least since a temperature and humidity level near air vents may be less affected by heat loss than other areas of Room 101, and therefore may provide effective measurements also in normal ongoing operation of HVAC Unit 110 and not only during a testing phase thereof. In some cases, sensors may be deployed at an ambient place in Room 101, at the incoming air location, near a compressor or engine of HVAC Unit 110, at locations that correspond to the thermodynamic cycle of the system, near doors, near windows, or the like.

In some exemplary embodiments, Room 101 may comprise openings devices associated with one or more openings of Room 101, such as Window 130. In some exemplary embodiments, the opening devices may include a window controller, which may be configured to control an opening or closing of Window 130, of a Window Covering 135, of window blinds, or the like. In some exemplary embodiments, the opening devices may include a door controller, which may be configured to control an opening or closing of one or more doors (not illustrated) of Room 101. In some exemplary embodiments, one or more detection sensors may be configured to detect a state of Window 130, indicating whether or not Window 130 is open, a state of Window Covering 135, a door state, or the like. In some exemplary embodiments, the opening devices may comprise automatic devices or mechanical means that are configured to be activated manually.

In some exemplary embodiments, one or more computing units, referred to as ‘control units’ (not illustrated) may be used to utilize one or more cooling and/or heating systems such as HVAC Unit 110, one or more sensors such as Sensor 120, one or more opening controllers, or the like, such as for performing a testing phase. In another embodiment, in case the controller unit is not deployed, User 140 may be asked to manually control the one or more cooling and/or heating systems, sensors, or the like, e.g., by using Remote Control 115, by pressing buttons on HVAC Unit 110, or the like. In some exemplary embodiments, the control unit may be embedded in one or more devices, e.g., in a user device, a laptop, in Sensor 120, in HVAC Unit 110, or the like. Alternatively, the control unit may be independently distributed, deployed, activated, or the like. For example, Sensor 120 and the control unit may be separate devices. As another example, Sensor 120 and the control unit may compose a single device, e.g., in which both the control unit and Sensor 120 are embedded. In some cases, the control unit may comprise multiple units, e.g., one or more embedded units, one or more independent units, a combination thereof, or the like.

In some exemplary embodiments, the control unit may interact with HVAC Unit 110, with fans, ACs, or the like, which may comprise “smart” devices with communication interfaces, computer processors, or the like, “dumb” devices without such equipment, or the like. In some exemplary embodiments, the control unit may control HVAC units and sensors remotely or locally, such as from a remote server, a computing device, a smartphone, or the like, which may be configured to instruct devices or sensors by sending instruction messages or signals thereto, utilizing a remote controller, mimicking messages of a remote controller, or the like. In some exemplary embodiments, the messages to the controlled devices may be provided via a communication medium such as Radio Frequency (RF) communications, WI-FI™ or Internet communications, BLUETOOTH™ communications, ultrasonic communications, Infrared (IR) communications, or the like. In some cases, the control unit may control different devices using different types of messages and communication mediums, according to corresponding receivers and communication protocols of the devices.

In some exemplary embodiments, a model or profile of Room 101, HVAC Unit 110, or the like, may be generated, obtained, determined, or the like, such as by the control unit. In some exemplary embodiments, the profiles of Room 101, HVAC Unit 110, or the like, may be provided by User 140, may be determined automatically by the control unit, may be obtained from a server, a combination thereof, or the like. For example, User 140 may be asked to provide properties of Room 101, including properties of Window 130, a space volume, air directions, or the like. As another example, the control unit may automatically utilize readings from Sensor 120 or from any other sensor, e.g., a range sensor, to measure and determine properties of Room 101.

In some exemplary embodiments, the profile of Room 101 (e.g., also referred to as the ‘environment profile’) may indicate a material of walls of Room 101, a two dimensional size of Room 101, a three dimensional volume of Room 101, relative locations of deployed devices such as HVAC Unit 110 within Room 101, a mapping of items within Room 101, relative locations of sensors within Room 101, openings and/or devices within Room 101, types, directions, and sizes of openings such as windows and doors within Room 101, measures of items within Room 101, or any other characterization, properties, layouts, or parameters of Room 101.

In some exemplary embodiments, the profile of HVAC Unit 110 (e.g., also referred to as the ‘device profile’) may indicate properties of HVAC Unit 110 such as a name of a model of HVAC Unit 110, specifications of HVAC Unit 110, a name of a manufacturer of HVAC Unit 110, a brand of HVAC Unit 110, a type of HVAC Unit 110, a strength of an engine of HVAC Unit 110, a mapping of components of HVAC Unit 110, other properties of the engine, or any other characterization, properties, layouts, or parameters of HVAC Unit 110.

In some exemplary embodiments, after obtaining the profiles of Room 101, HVAC Unit 110, or the like, prior to obtaining the profiles, in parallel thereto, or the like, a testing phase may be implemented in order to test an influence of HVAC Unit 110 on Room 101. In case the testing phase is performed after obtaining the profiles of Room 101, HVAC Unit 110, or the like, the influence of HVAC Unit 110 on Room 101 may be determined based on the profiles and based on the testing phase. In some exemplary embodiments, the testing phase may include performing one or more testing sequences associated with HVAC Unit 110, User 140, or the like, and measuring effects of each action of a testing sequence. In some exemplary embodiments, a testing sequence may be performed automatically, manually, a combination thereof, or the like, e.g., with or without involvement of User 140. In case the testing phase is performed after obtaining the profiles of Room 101, HVAC Unit 110, or the like, testing sequences may be selected, e.g., by the control unit, based on the profiles.

In some exemplary embodiments, in order to implement the testing phase in a controlled environment, a testing sequence may define an initial state, layout, setting, or the like, of Room 101. For example, the testing sequence may comprise instructions to prepare Room 101, or alternatively, Room 101 may be required to be prepared to a certain layout before performing the testing sequence. For example, a testing sequence may define an initial state in which all openings of Room 101, including Window 130, are to be shut, and all living subjects, including User 140, are to leave Room 101 for a defined time frame. As another example, a testing sequence may define an initial state in which the openings of Room 101 are shut except for Window 130. In some exemplary embodiments, the initial state of Room 101 may be reached manually, such as by User 140, automatically, such as using automatic opening controllers, a combination thereof, or the like. For example, Room 101 may be prepared as a controlled environment manually by User 140, such as in response to the control unit sending instructions to be presented to User 140. Instructions may be presented to User 140 via a user interface of a screen of a computing device, as notifications to a user device, messages to a user device, or the like.

In some exemplary embodiments, a testing sequence may comprise a defined sequence of actions according to a defined order. In some exemplary embodiments, the testing sequence may be performed automatically, such as by generating control signals or instruction at the control unit, manually, such as by User 140, or the like. For example, in case the control unit is not deployed, User 140 may be asked to manually adjust the setting of HVAC Unit 110 to one or more defined configurations according to the testing sequence, to close Window 130, to isolates Room 101, or the like, in order to enable a testing of HVAC Unit 110's effects on Room 101.

In some exemplary embodiments, measurements may be performed in association with the actions, such as by Sensor 120, in order to identify an influence of the actions on a temperature of Room 101. In some exemplary embodiments, after each action of a testing sequence, Sensor 120 may record measurements, such as temperature measurements, and store them in a cloud storage, a local database, or the like. In some exemplary embodiments, the measurements may include temperature measurements in one or more areas of the room, humidity measurements, or the like, which may measure internal parameters that are internal to the room. For example, a testing sequence may comprise instructing HVAC Unit 110 to increase the temperature to a maximum level, e.g., 31 degrees, by increasing a degree every 5 seconds until reaching the highest degree, until reaching a defined degree, or the like. After every action is estimated to be performed, or upon detecting that an action has been performed, the resulting temperature may be measured, e.g., by Sensor 120. For example, actions may be determined to be performed by using a spoofing receiver, using an audio sensor to detect a noise produced by HVAC Unit 110 after changing a temperature, or the like. In some exemplary embodiments, other measurements that may be performed during the testing phase may include a measuring a sound level of the appliance, a sound level of the engine of the appliance, an air flow, an engine temperature, an engine pressure, incoming and/or outgoing air temperatures, refrigerant pressures, error codes, or the like, obtaining readings from a thermal camera, readings from a digital camera, or the like. For example, in case that a smart electricity meter that is able to record power consumption is deployed in the room, the power consumption of the HVAC device may be measured, stored, and correlated to the testing phase stages.

In some exemplary embodiments, a temperature profile, including a model of the equipment thermodynamics in Room 101, may be generated, e.g., based on the testing phase, the profiles of Room 101 and HVAC Unit 110, or the like. In some exemplary embodiments, the temperature profile may be configured to indicate effects of different settings of HVAC Unit 110 on a temperature of Room 101. In some exemplary embodiments, the temperature profile may be utilized for performing comparisons to other profiles, parameters, or the like, in order to extract insights. In some exemplary embodiments, the temperature profile may be utilized in a non-controlled environment, such as during a regular usage of HVAC Unit 110 by User 140. In some exemplary embodiments, ongoing measurements may be performed in a non-controlled environment during the usage of HVAC Unit 110, and recommendations may be generated based on the measurements and the temperature profile.

In some exemplary embodiments, the temperature profile may be adjusted, refined, or the like, such as based on ongoing measurements of sensors within Room 101. In some exemplary embodiments, the heat exchange between Room 101 and the outside environment may be determined based on a correlation between ongoing measurements within Room 101, with one or more parameters of an outside weather outside of Room 101. For example, outside sensors may measure an outside temperature, an outside humidity level, an outside weather, or the like. In some cases, the control unit may obtain communications from third party servers indicating localized weather data. In case the engine of a heating and/or cooling system is located outside, such as in the case of a heat pump's compressor, outside temperature data may be used to model the weather's influence on the engine's efficiency during ongoing usage, during a testing phase, or the like.

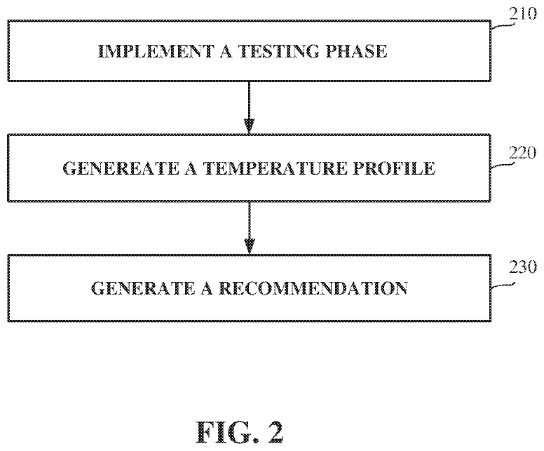

Referring now to FIG. 2, showing an exemplary flowchart diagram of a method, in accordance with some embodiments of the disclosed subject matter.

On Step 210, a testing phase may be implemented, performed, or the like, in an environment, such as a room where at least one HVAC unit is deployed. In some exemplary embodiments, in case the environment comprises two or more HVAC units, a testing phase may be performed individually for each HVAC unit in the environment. In some exemplary embodiments, the testing phase may be configured to test an influence of an HVAC unit on a temperature of the environment.

In some exemplary embodiments, the testing phase may comprise performing at least one testing sequence, each of which comprising a sequence of two or more actions. In some exemplary embodiments, at least a portion of the two or more actions may be performed or implemented automatically. In some cases, a portion of the two or more actions may be configured to be implemented manually, e.g., by a user. In some exemplary embodiments, the sequence of two or more actions may comprise an action of instructing the HVAC unit to change its target temperature by one or more degrees, an action of instructing a user to perform one or more activities, or the like.

In some exemplary embodiments, the sequence of two or more actions may comprise a manual action such as an evacuation action, which may comprise an instruction to vacate living subjects from the environment. In some exemplary embodiments, the sequence of two or more actions may comprise an action instructing the user, or instructing one or more devices, to adjust an external influence on the environment. In some exemplary embodiments, the instruction to adjust external influence on the environment may comprise an instruction that modifies a state of an object within the environment, which is estimated to affect external influence on the temperature within the environment. For example, the environment may comprise a room, and the action to adjust external influence on the environment may comprise instructing to adjust a state of an opening of the room, such as a window, a door, or the like, e.g., by closing the opening, opening the opening, or the like. The action may be instructed to be performed manually or automatically, e.g., based on properties of the room.

In some exemplary embodiments, effects of two or more actions of a testing sequence on the temperature of the environment may be measured. In some exemplary embodiments, measuring the effects may be performed based on sensor readings from one or more sensors that may be deployed inside the environment, adjacently thereto, or the like. In some exemplary embodiments, at least one sensor of the one or more sensors may be external to the HVAC unit, e.g., including an independent sensor that may be independently distributed, deployed, or the like, and may not be embedded within the HVAC unit. For example, deployed sensors in the environment may comprise temperature sensors, range sensors, automatic opening or closing sensors, or the like.

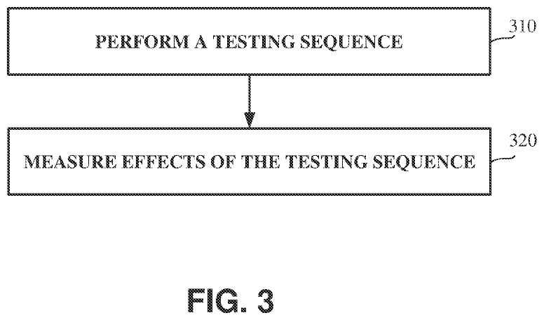

In one exemplary scenario, a testing sequence may comprise instructing the HVAC unit to provide a minimum temperature, by reducing a degree of the HVAC unit one by one, measuring by the one or more sensors a first temperature of the environment during a first subsequent time frame subsequently to reaching the lowest temperature, instructing the HVAC unit to provide a maximal temperature, and measuring a second temperature of the environment during a second subsequent time frame subsequently to reaching a highest temperature. In some exemplary embodiments, an effective minimum and maximum temperatures that can be produced by the HVAC unit in the environment may be determined based on this testing sequence. In other scenarios, in any testing sequence may be used, e.g., testing sequences described in Step 310 of FIG. 3.

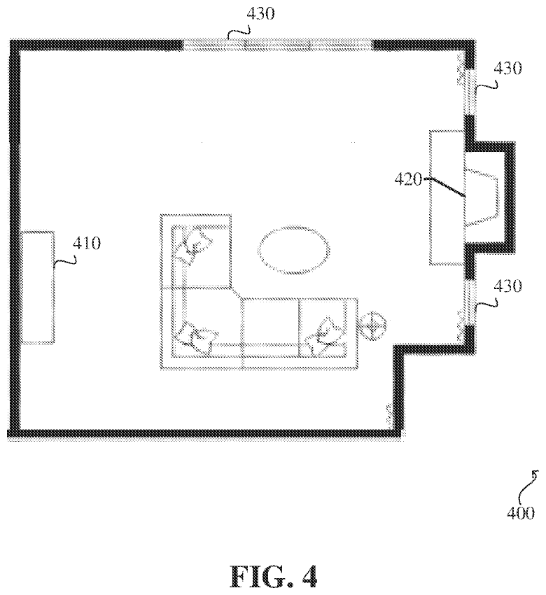

In some exemplary embodiments, in order to generate an accurate model of the equipment thermodynamics in the environment, space, room, or the like, the user may be suggested or instructed to provide one or more properties of the environment, one or more properties of the HVAC device, or the like, as user inputs, e.g., via a user interface of FIG. 4. In some exemplary embodiments, instead of the user input, or in addition thereto, the model of the equipment thermodynamics may be generated based on automatically determined environment parameters and/or HVAC device parameters. In some exemplary embodiments, based on the user input, the automatically determined parameters, or the like, an environment profile of the room may be generated, and a device profile of the HVAC device may be generated.

In some exemplary embodiments, in order to implement a testing phase in a room, one or more testing sequences may be selected from a set of multiple testing sequences, a database thereof, a repository, or the like. In some exemplary embodiments, the selection of testing sequences may be performed based on one or more properties of the environment (e.g., as indicated by the environment profile), based on the properties of the HVAC unit (e.g., as indicated by the device profile), based on a time constraint or limit indicated by a user of the HVAC unit, based on user preferences, or the like. In some cases, the set of multiple testing sequences may comprise at least one additional testing sequence that is not selected to be included in a testing sequence, thereby not performing the additional testing sequence in the environment. For example, in case a testing sequence is not relevant for rooms with a certain wall type, and a current environment includes a room with the certain wall type, the testing sequence may not be selected to be performed for a testing phase of the room.

In some exemplary embodiments, the testing phase may be initiated manually, such as by a user, a third party entity such as a technician, a manufacturer, or the like. In some exemplary embodiments, the testing phase may be initiated automatically, such as based on heuristics, time thresholds, determined seasons, outside environment conditions such as weather conditions, properties of the HVAC device, ongoing or periodic sensor measurements, or the like. For example, in case a defined condition is determined to be fulfilled based on sensor readings, a testing phase may be determined to be implemented for an environment, scheduled, or the like.

On Step 220, a temperature profile may be generated based on the testing phase, based on the environment profile, based on the device profile, or the like. In some exemplary embodiments, the temperature profile may indicate the influence of the HVAC unit on the temperature of the environment. For example, the temperature profile may indicate an effective minimum temperature that can be produced by the HVAC unit in the environment, an effective maximum temperature that can be produced by the HVAC unit in the environment, a rate of heat loss from the environment, a rate of heat transfer to the environment, or the like.

On Step 230, a recommendation may be generated, e.g., based on the temperature profile. In some exemplary embodiments, the recommendation may include one or more recommendations for a utilization or setting of the HVAC unit, one or more recommendations for adjusting at least one property of the environment, or the like. For example, the recommendation may recommend the user to avoid setting the HVAC unit to a temperature that cannot be reached in the environment, e.g., based on the effective minimum or maximum temperature of the environment. As another example, the recommendation may recommend the user modify a property of the room, such as to replace a window or any other object in the room, change a location of the window, change a setting of the window (e.g., closing the window, applying window coverings, or the like), to cover or replace a wall that allows heat to enter (e.g., a glass wall), changing a deployment location or other setting of a sensor, or the like. In some exemplary embodiments, the recommendation may be generated based on the temperature profile, based on the one or more properties of the environment, based on the one or more properties of the HVAC device, a combination thereof, or the like.

In some exemplary embodiments, a recommendation may be generated based on a comparison between the temperature profile and one or more additional temperature profiles. In some exemplary embodiments, the additional temperature profiles may comprise temperature profiles of other HVAC units, previous temperature profiles of the same HVAC units, or the like. In some exemplary embodiments, the additional temperature profiles may comprise temperature profiles that share one or more attributes with the environment of the current temperature profile, with the HVAC unit of the current temperature profile, or the like.

In some exemplary embodiments, the recommendation may be generated based on a comparison between the temperature profile, and temperature profiles of multiple HVAC units in other environments having a similar environment, e.g., an environment profile that is within similarity measurement threshold to an environment profile of the environment, that has one or more overlapping attributes or properties with the temperature profile, or the like. In some exemplary embodiments, based on the comparison, one or more insights may be determined, e.g., derived properties of the environment, derived properties of the HVAC unit, or the like. For example, an isolation level of the environment may be determined based on the comparison, and the recommendation may be generated to adjust the isolation level of the environment. As another example, in case multiple environments that are similar to the current environment have a same determined property, the property may be determined to be added to the environment profile, thereby affecting the temperature profile. As another example, a performance measurement of the HVAC unit, including one or more performance properties of the HVAC unit such as an average life span of the unit before degradation, may be determined based on the comparison.

In some exemplary embodiments, a recommendation may be generated based on a comparison between the temperature profile and previous temperature profiles that were generated for the HVAC unit. In some exemplary embodiments, one or more changes over time may be determined based on the comparison. In some exemplary embodiments, the changes may be determined to include changes of the room properties, changes of a functionality of the HVAC unit, or the like. For example, a degradation of a functionality of the HVAC unit may be detected within the environment based on said comparison. In some exemplary embodiments, one or more comparisons may be combined or used in combination. For example, the degradation of the functionality of the HVAC unit may be detected based on historic degradation periods of the same type of HVAC unit in different environments, in combination with the comparison of the temperature profile to previous profiles of the same environment indicating a reduction in functionality.

In some exemplary embodiments, one or more decisions or insights may be determined based on one or more comparisons of the temperature profile with other temperature profiles. For example, a timing, scheduling, initiation, or the like, of testing phases may be determined or scheduled based on historic information associated to a type of the device, derivations thereof, determined detections of efficiency degradation, or the like, which may be determined based on a combination of one or more comparisons. For example, an initiation of the testing phase may be scheduled automatically, such as upon determining that a brand of the HVAC system has a history degrading at a certain point in time for similar users that use the HVAC system in a similar frequency.

Referring now to FIG. 3, showing an exemplary flowchart diagram of a method, in accordance with some embodiments of the disclosed subject matter.

On Step 310, during a testing phase, such as a testing phase described in Step (FIG. 2), at least one testing sequence may be performed, implemented, or the like. In some exemplary embodiments, a testing sequence may comprise a sequence of two or more actions. In some exemplary embodiments, instructions to perform the two or more actions may be automatically generated, attempting to cause the actions to be implemented manually, automatically, or the like.

In some exemplary embodiments, a testing sequence may comprise an ordered sequence of instructions that can affect a temperature in the environment, such as by instructing a deployed AC to increase its temperature to a maximum level, instructing the AC to decrease the temperature to a maximum level, instructing the user to open a window, or the like. After each action, change in a setting, or the like, the temperature in the room may be measured. In some exemplary embodiments, after each action that is performed, a measurement may be made to measure an effect of the action on a temperature of the environment.

In some exemplary embodiments, in order to determine the efficiency of cooling and heating systems such as a HVAC unit, the testing sequence may be implemented in a controlled environment. In some exemplary embodiments, in some cases, instructions to create a controlled environment may be included as part of the testing sequence, may be implemented externally to the testing sequence, or the like. In some cases, a testing sequence may be configured to create a controlled environment by instructing a user or an automatic controller to close openings thereof, e.g., doors of room, windows, window coverings, or the like, instructing to open one or more openings, instructing the user to leave the room for a defined time period, instructing to vacate living subjects from the room, or the like. For example, the user may be instructed to leave the room for 30 minutes, an hour, two hours, or the like.

In some exemplary embodiments, one or more testing sequences may be configured to be performed after isolating the room, such as after vacating living subjects therefrom and closing openings, covering heat conductors such as glass walls, or the like. In some exemplary embodiments, a testing sequence that is configured to determine the heat loss rate from the environment, rate of heat transfer to the environment, rates of cooling and warming the environment, or the like, may be implemented. In some exemplary embodiments, the testing sequence may comprise isolating the room, and then turning off the AC, until reaching the room temperature. In some exemplary embodiments, the testing sequence may be configured to cool the room for a time frame, e.g., 30 minutes, to a minimum temperature, and then heating the room for a same or different time frame, e.g., 30 minutes, to a maximum temperature. For example, after isolating the room by one or more manual or automatic actions of the testing sequence, and reaching a room temperature, a temperature of the room may be decreased one degree by one, and then iteratively the degrees may be increased one by one. After every decrease or increase in a single degree, in two or more degrees, or the like, measurements may be made to detect effects of the change on a temperature of the room.

In some cases, as a result of the testing sequence, a lowest temperature may be determined, e.g., indicating the temperature that was measured after 30 minutes of cooling. In some exemplary embodiments, parallel temperatures may be determined, e.g., indicating different degrees that are instructed to the AC that result with a same temperature. For example, in case that an action that instructs the AC to cool the room to degrees, results with the room reaching a temperature of 19 degrees, and an action that instructs the AC to cool the room to 19 degrees also results with the room reaching a temperature of 19 degrees, the temperature instructions to the AC may be determined to be parallel. In some exemplary embodiments, in the case of parallel temperature instructions, the user may be recommended to never use the lower temperature, e.g., of degrees, when cooling the room. In some exemplary embodiments, the same may be performed vice versa, e.g., to determine a maximum temperature. For example, in case that an action that instructs the AC to warm the room to 19 degrees, results with the room reaching a temperature of 18 degrees, and an action that instructs the AC to warm the room to 18 degrees also results with the room reaching a temperature of 18 degrees, the temperature instructions to the AC may be determined to be parallel, and the user may be recommended to never use the higher temperature, e.g., of 19 degrees, when attempting to warm the room.

In some exemplary embodiments, a second testing sequence may be performed by isolating the room to a defined setting, e.g., by closing the openings of the room, covering heat conducting areas, or the like. In some exemplary embodiments, after reaching a room temperature, or regardless thereof, the testing sequence may include instructing the HVAC unit to cool the room to a defined temperature for a defined time frame, and then instructing to open one or more room openings (e.g., a window). In some exemplary embodiments, after opening the window, the HVAC unit may be instructed to cool the room to the same temperature for the same time frame. In some exemplary embodiments, this testing sequence may enable to determine an energetic cost of opening the window, or any other room opening. In some exemplary embodiments, the energetic cost may be determined based on one or more sensor readings, e.g., indicating temperature changes before and after the window was open, an outside weather, or the like, e.g., at Step 320. In some exemplary embodiments, an energetic cost of different settings of the HVAC unit or the room may be determined based on the determined cost of opening the window. For example, in case the window is open, the minimum temperature that can be reached may be adjusted, and recommendations may be generated based thereon. As another example, the user may be instructed to close the window.

In some exemplary embodiments, the second testing sequence may be performed with respect to warming the room, e.g., by a third testing sequence. In some exemplary embodiments, one or more corresponding testing sequences that correspond to the second testing sequence may be performed with respect to covering areas of the room that enable heat or cold transfer, that have high conductivity (e.g., above a threshold), or the like. In some exemplary embodiments, the testing sequences may be performed in a controlled environment, such as an environment with isolation settings that was prepared by generating one or more preparation instructions, or in an uncontrolled environment, such as during a day to day usage of the HVAC unit. For example, upon detecting in an uncontrolled environment that a window was opened, and upon obtaining measurements of an outside weather, the effective temperature of the room may be measured and compared to the effective temperature of the room before the window was opened.

In some exemplary embodiments, a third testing sequence may be performed by isolating the room, reaching a room temperature, and instructing the HVAC unit to cool or heat the room using different settings of the HVAC unit. For example, the HVAC unit may be instructed to cool the room to one or more defined temperatures, and then the HVAC unit may be instructed to use a fan mode. In some exemplary embodiments, the effect of the different settings may be compared to each other in order to identify differences. For example, the fan mode, which may generally not reduce the room temperature, may be determined to affect the room temperature in one or more ways, which may have an impact on an energetic cost of the HVAC unit. In some exemplary embodiments, any other testing sequence may be performed.

On Step 320, effects of the testing sequence may be measured. In some exemplary embodiments, after each action of the testing sequence, a temperature of the room may be measured by one or more sensors. In some exemplary embodiments, any other property of the room may be measured. In some exemplary embodiments, a temperature may be measured after each set of one or more degrees that is instructed to be increased or decreased. For example, a cooling operation of a testing sequence may be implemented by instructing the HVAC unit to decrease one degree every time frame (e.g., every 10 seconds), and the temperature may be measured after each such instruction. Alternatively, the temperature may be measured after a change of two or more degrees, after two or more actions, or the like.

In some exemplary embodiments, the measurements may be made upon the testing sequence being used to generate an instruction to the user or HVAC unit, a defined delay period after each instruction, or the like. In some exemplary embodiments, the measurements may be made periodically, e.g., every second, or continuously. In some exemplary embodiments, the measurements may be logged, stored, or the like, and used to compare effects of actions, and thereby generate temperature profiles. In some exemplary embodiments, the measurements may be stored locally for a defined period of time, e.g., until the profile is generated, or may be stored externally, such as at a server. In some exemplary embodiments, the testing sequences may be stored locally, at a server, or the like.

Referring now to FIG. 4 showing an exemplary room model, in accordance with some exemplary embodiments of the disclosed subject matter.

In some exemplary embodiments, one or more two dimensional room models, three dimensional room models, or the like, may be utilized to indicate properties of an environment in which a HVAC unit such as HVAC Unit 410 is deployed, properties of HVAC Unit 410 itself, or the like. For example, a two dimensional model including Room Model 400 may represent a room. As another example, a three dimensional model including Environment 100 (FIG. 1) may be utilized to represent a room. In other cases, Room Model 400 may comprise any other model that represents an environment in which HVAC Unit 410 is deployed, in any other dimension, type, representation method, or the like. In some exemplary embodiments, Room Model 400 may indicate properties of an environment profile, a device profile, or the like, and may be used to generate the environment and device profiles, may be generated based on the environment and device profiles, or the like. In some exemplary embodiments, Room Model 400 may be adjusted or created automatically, manually, or the like. In some cases, Room Model 400 may be generated based on one or more properties that are determined based on manual user input, one or more properties that are determined automatically based on sensor readings, or the like.

In some exemplary embodiments, Room Model 400 may be generated based on one or more properties of the environment such as a size of the room, a location of HVAC Unit 410 in the environment, relative locations of air vents and air ducts in the environment, a direction of air vents in the environment, dimensions of air vents, a height level of air vents in the environment, a location of sensors used to obtain measurements within the environment, a two-dimensional volume or area of the environment, a three-dimensional volume of the environment, locations of each Window 430 in the environment or portion thereof, sizes of each Window 430 in the environment or portion thereof, locations of each Door 420 in the environment or portion thereof, sizes of each Door 420 or other opening in the environment or portion thereof, a type and location of high conducting areas of the room (e.g., glass walls), high conducting walls of the room, a type, size, number and/or location of Windows 430 in the room, a size, type, and/or location of Doors 420 within the room, a direction to which each opening faces, a material from which the walls are made of, indications of a cardinal or primary direction with respect to the environment, or the like.

In some exemplary embodiments, Room Model 400 may be generated based on one or more properties of HVAC Unit 410, such as a model of HVAC Unit 410 in the environment, a brand of HVAC Unit 410, dimensions of air flaps of HVAC Unit 410, a location of sensors that are embedded within HVAC Unit 410, a size of HVAC Unit 410, a type of engine that is used by HVAC Unit 410 (e.g., an inverter, a heater, or the like), a strength of the engine (e.g., measured in horsepower, British Thermal Unit (BTU), kilowatt consumption, or the like), other properties of an engine of HVAC Unit 410, properties of a compressor of HVAC Unit 410, an age of HVAC Unit 410, a power consumption of HVAC Unit 410 (e.g., as provided by the manufacturer), a date and type of a last maintenance operation of HVAC Unit 410, or the like. In other cases, Room Model 400 may not utilize the properties of HVAC Unit 410, and a separate device model (not illustrated) may be generated based on the properties of HVAC Unit 410.

In some exemplary embodiments, in case Room Model 400 is generated at least partially in a manual manner, user inputs may be obtained from a user. In some exemplary embodiments, the user input may be provided by a user via a screen of a computing device, buttons of a computing device, input elements or devices of a computing device, a user interface of the HVAC unit, or the like. For example, the properties of the environment may be obtained by presenting to a user a visual illustration or representation of the environment via a graphical user interface, and receiving user instructions defining the one or more properties of the environment with respect to the visual illustration of the environment. In some cases, the user may be provided with suggestions of potential values, states, or the like, such as based on common features of rooms, and the user may indicate properties of the environment by selecting proper suggestions.

In some cases, an initial model of a room may be generated automatically, and the user may adjust properties thereof to obtain Room Model 400. In other cases, the initial model may be generated or created by the user, obtained from a server, obtained from a third party entity, or the like. For example, the initial model may comprise a geometrical shaped room, such as a square room, without specific properties such as a location of Windows 430, Doors 420, HVAC Units 410, or the like. In some exemplary embodiments, a user may be configured to supply specifications of the room, e.g., properties of the environment, of HVAC Unit 410, or the like, such as by adjusting a size of the initial model of Room Model 400 to match an actual size of the room, inserting objects into the initial model of Room Model 400 according to the actual deployment of objects in the room, or the like. For example, the user may obtain an empty version of Room Model 400, and insert therein Windows 430 in their appropriate locations, Door in its corresponding location, a location and dimension of HVAC Unit 410, or the like. In some cases, Room Model 400 may not depict furniture objects that are not part of a cooling or heating system (not illustrated).

In some exemplary embodiments, in case Room Model 400 is generated at least partially in an automatic manner, one or more properties of the environment may be obtained automatically and used to generate Room Model 400. In some exemplary embodiments, instead of the user input, or in addition thereto, Room Model 400 may be generated based on automatically determined environment parameters, automatically determined HVAC device parameters, automatically determined environment profiles, automatically determined device profiles, or the like. In some exemplary embodiments, one or more properties of the environment may be obtained automatically, such as based on sensor readings, third party data, heuristics, or the like. In some exemplary embodiments, environment parameters, HVAC device parameters, or the like, may be detected automatically in case sensors that enable to generate such parameters are present in the environment or adjacently thereto. For example, a brand of an HVAC device may be determined automatically based on a remote control protocol of the air conditioner that may be detected by a radio receiver. As another example, a size or volume of the environment may be determined using range sensors. As another example, relative locations of one or more deployed sensors within the environment may be determined automatically based on sensor-based measurements.

In some exemplary embodiments, Room Model 400 may be generated based on manual and automatically generated inputs, properties, or the like. For example, a user may provide a model name of HVAC Unit 410 manually, and additional properties of HVAC Unit 410 may be determined automatically such as by extracting properties of HVAC Unit 410 from a database of HVAC unit properties, and using the name of the model of HVAC Unit 410 as a query. As another example, a user may provide a type of window coverings such as Window Covering 135 (FIG. 1) that is used to cover Windows 430, and based thereon properties of Windows 430 may be determined, e.g., a material of Windows 430, the dimensions of Windows 430, or the like.

In some exemplary embodiments, Room Model 400 may be generated prior to performing a testing phase such as the testing phase of Step 210 (FIG. 2), such as in order to select testing sequences or adjust parameters thereof. In some exemplary embodiments, Room Model 400 may be generated at any other time, such as after performing a testing phase, while processing results of a testing phase, or the like. In some exemplary embodiments, based on Room Model 400, one or more insights may be extracted, a temperature profile may be determined, a model of the equipment thermodynamics in the room may be determined, an environment profile of the room may be determined, a device profile of HVAC Unit 410 may be determined, or the like.

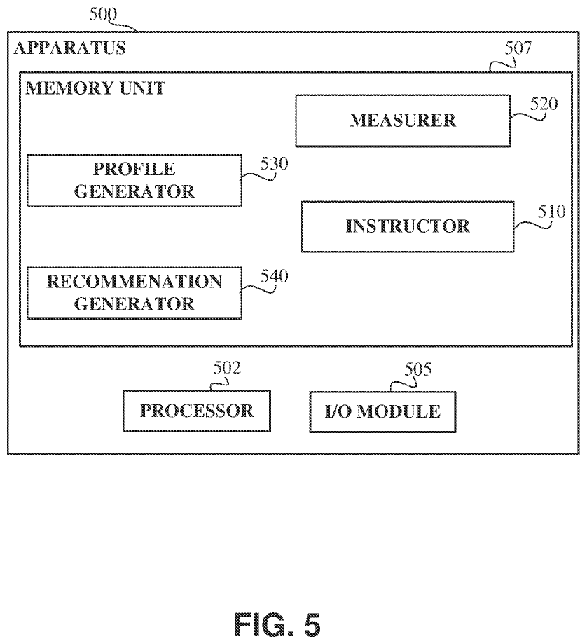

Referring now to FIG. 5 showing an exemplary block diagram of an apparatus, in accordance with some exemplary embodiments of the disclosed subject matter.

In some exemplary embodiments, an Apparatus 500 may comprise a Processor 502. Processor 502 may be a Central Processing Unit (CPU), a microprocessor, an electronic circuit, an Integrated Circuit (IC) or the like. Processor 502 may be utilized to perform computations required by Apparatus 500 or any of its subcomponents. Processor may be configured to execute computer-programs useful in performing the method of FIGS. 2-3, or the like.

In some exemplary embodiments of the disclosed subject matter, an Input/Output (I/O) Module 505 may be utilized to provide an output to and receive input from a user device, sensors, a user interface, or the like. I/O Module 505 may be used to transmit and receive information to and from any apparatus in communication therewith, to present data to users, or the like. I/O Module 505 may be used to transmit instructions to one or more sensors, HVAC units, user devices, or the like, to present instructions to human subjects, or the like.

In some exemplary embodiments, Apparatus 500 may comprise a Memory Unit 507. Memory Unit 507 may be a short-term storage device or long-term storage device. Memory Unit 507 may be a persistent storage or volatile storage. Memory Unit 507 may be a disk drive, a Flash disk, a Random Access Memory (RAM), a memory chip, or the like. In some exemplary embodiments, Memory Unit 507 may retain program code operative to cause Processor 502 to perform acts associated with any of the subcomponents of Apparatus 500. In some exemplary embodiments, Memory Unit 507 may retain program code operative to cause Processor 502 to perform acts associated with any of the steps in FIGS. 2-3, or the like.

The components detailed below may be implemented as one or more sets of interrelated computer instructions, executed for example by Processor 502 or by another processor. The components may be arranged as one or more executable files, dynamic libraries, static libraries, methods, functions, services, or the like, programmed in any programming language and under any computing environment.

In some exemplary embodiments, Memory Unit 507 may comprise an Instructor 510. In some exemplary embodiments, Instructor 510 may be configured to implement one or more testing sequences in an environment as part of a testing phase. In some exemplary embodiments, Instructor 510 may be configured to instruct a user, a HVAC device, or the like, to perform one or more manual or automatic actions. In some cases, manual actions may comprise changing a setting of the HVAC device via a remote controller, via buttons of the HVAC device, or the like, changing settings of the room, such as by opening a door of the room, or the like. In some cases, automatic actions may comprise controlling the HVAC device automatically, without user intervention, such as by transmitting control signals thereto, automatically controlling features of the environment, such as by opening a door using automatic door openers, or the like.

In some exemplary embodiments, Memory Unit 507 may comprise a Measurer 520. In some exemplary embodiments, Measurer 520 may be configured to measure an effect of each action that is instructed to be performed by Instructor 510, on a temperature of the room.

In some exemplary embodiments, Memory Unit 507 may comprise a Profile Generator 530. In some exemplary embodiments, Profile Generator 530 may be configured to generate, based on measurements of Measurer 520 and the instructions of Instructor 510, a temperature profile indicating an effect of the HVAC unit on the temperature of the room.

In some exemplary embodiments, Memory Unit 507 may comprise a Recommendation Generator 540. In some exemplary embodiments, Recommendation Generator 540 may be configured to generate one or more recommendations based on the temperature profile. In some exemplary embodiments, Recommendation Generator may generate recommendations associated with ongoing activity of the HVAC unit, such as a recommendation to use certain settings in certain scenarios, not to use certain settings in other scenarios, or the like. For example, Recommendation Generator 540 may recommend not to set a temperature that is lower than the effective minimum temperature of the HVAC unit, not to leave a window open when an outside temperature is above a threshold, or the like. In some exemplary embodiments, Recommendation Generator 540 may generate recommendations associated with a general layout of the room, such as a recommendation to change a location or deployment of the HVAC unit, a recommendation to change a location or type of window, a recommendation to renovate the room, or the like.

In some exemplary embodiments, Recommendation Generator 540 may obtain or generate one or more environment profiles, device profiles, or the like (e.g., Room Model 400), and generate recommendations based thereon. Alternatively, any other component of Apparatus 500 may be used to obtain or generate one or more environment profiles, device profiles, or the like. For example, Instructor 510 may be configured to obtain or generate environment profiles, device profiles, or the like, and select a testing sequence to be implemented based thereon.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method operated in an environment where a Heating, Ventilation, or Air Conditioning (HVAC) unit is deployed, the method comprising:
performing a testing phase, wherein the testing phase is configured to test an influence of the HVAC unit on a temperature of the environment, wherein the testing phase comprises:
performing at least one testing sequence, wherein a testing sequence of the at least one testing sequence comprises a sequence of two or more actions, wherein at least one action of the two or more actions comprises instructing the HVAC unit to change its target temperature, and
performing measurements of effects of the two or more actions on the temperature of the environment;
based on the testing phase, generating a temperature profile, wherein the temperature profile indicates the influence of the HVAC unit on the temperature of the environment; and
based on the temperature profile, generating a recommendation for a utilization of the HVAC unit.

2. The method of claim 1 further comprising: obtaining one or more properties of the environment, wherein said generating the recommendation is based on the one or more properties of the environment.

3. The method of claim 2, wherein the one or more properties of the environment comprise at least one of:
a location of the HVAC unit in the environment;
a location of sensors used to obtain the measurements within the environment;
a two-dimensional area of the environment;
a three-dimensional volume of the environment;
locations of each window in the environment or portion thereof;
sizes of each window in the environment or portion thereof;
locations of each door opening in the environment or portion thereof;
sizes of each door opening in the environment or portion thereof; and
an indication of a cardinal direction with respect to the environment.

4. The method of claim 2 comprising performing a comparison between the temperature profile and one or more additional temperature profiles, wherein the one or more additional temperature profiles comprise temperature profiles of multiple HVAC units in other environments having environment profiles that are within a similarity measurement threshold to an environment profile of the environment, wherein the environment profile of the environment is based on measurements of the one or more properties, the method further comprising determining based on said comparison at least one of: an isolation level of the environment, and a performance measurement of the HVAC unit.

5. The method of claim 2, wherein said obtaining comprises:
presenting to a user via a graphical user interface a visual illustration of the environment; and
receiving user instructions defining the one or more properties of the environment with respect to the visual illustration of the environment.

6. The method of claim 1, wherein the measurements are performed based on sensor readings from one or more sensors that are deployed in the environment, wherein at least one sensor of the one or more sensors is external to the HVAC unit.

7. The method of claim 1, wherein the sequence of two or more actions comprises an evacuation action, wherein the evacuation action is an instruction to vacate living subjects from the environment.

8. The method of claim 1, wherein the sequence of two or more actions comprises an action to adjust external influence on the environment, wherein the action to adjust external influence on the environment comprises an instruction that modifies a state of an object within the environment in order to affect external influence on the temperature within the environment.

9. The method of claim 8, wherein the environment comprises a room, wherein the action to affect the external influence on the environment comprises instructing to adjust a state of an opening of the room, wherein the opening is one of: a window, and a door.

10. The method of claim 1 comprising selecting the at least one testing sequence from a set of multiple testing sequences, wherein the set of multiple testing sequences comprises an additional testing sequence that is not comprised in the at least one testing sequence, whereby not performing the additional testing sequence in the environment.

11. The method of claim 10, wherein said selecting is based on at least one of: one or more properties of the environment, and a time constraint indicated by a user of the HVAC unit.

12. The method of claim 1, wherein the temperature profile indicates at least one of:
an effective minimum temperature that can be produced by the HVAC unit in the environment;
an effective maximum temperature that can be produced by the HVAC unit in the environment;
a rate of heat loss from the environment; and
a rate of heat transfer to the environment.

13. The method of claim 1, wherein at least a portion of the two or more actions are performed automatically.

14. The method of claim 1 comprising performing a comparison between the temperature profile and one or more additional temperature profiles, wherein the additional temperature profiles comprise previous temperature profiles that were generated for the HVAC unit, wherein the method comprises detecting a degradation of a functionality of the HVAC unit within the environment based on said comparison.

15. The method of claim 1, wherein the recommendation comprises a recommendation for adjusting at least one property of the environment.

16. The method of claim 1, wherein the testing sequence comprises:
instructing to close openings of the environment;
instructing to vacate living subjects from the environment;
instructing the HVAC unit to provide a minimum temperature; and
instructing the HVAC unit to provide a maximum temperature,
wherein a first temperature of the environment is measured subsequently to instructing the HVAC unit to provide the minimum temperature, and a second temperature of the environment is measured subsequently to instructing the HVAC unit to provide the maximum temperature, whereby determining an effective minimum temperature that can be produced by the HVAC unit in the environment, and an effective maximum temperature that can be produced by the HVAC unit in the environment.

17. An apparatus comprising a processor and coupled memory, said processor being adapted to perform, in an environment where a Heating, Ventilation, or Air Conditioning (HVAC) unit is deployed, the steps of:
performing a testing phase, wherein the testing phase is configured to test an influence of the HVAC unit on a temperature of the environment, wherein the testing phase comprises:
performing at least one testing sequence, wherein a testing sequence of the at least one testing sequence comprises a sequence of two or more actions, wherein at least one action of the two or more actions comprises instructing the HVAC unit to change its target temperature, and
performing measurements of effects of the two or more actions on the temperature of the environment;
based on the testing phase, generating a temperature profile, wherein the temperature profile indicates the influence of the HVAC unit on the temperature of the environment; and
based on the temperature profile, generating a recommendation for a utilization of the HVAC unit.

18. The apparatus of claim 17, wherein the processor is adapted to perform a comparison between the temperature profile and one or more additional temperature profiles, wherein the one or more additional temperature profiles comprise temperature profiles of multiple HVAC units in other environments having environment profiles that are within a similarity measurement threshold to an environment profile of the environment, the processor is further adapted to determine, based on said comparison, at least one of: an isolation level of the environment, and a performance measurement of the HVAC unit.

19. The apparatus of claim 17, wherein the measurements are performed based on sensor readings from one or more sensors that are deployed in the environment, wherein at least one sensor of the one or more sensors is external to the HVAC unit.

20. A computer program product comprising a non-transitory computer readable medium retaining program instructions, which program instructions when read by a processor, cause the processor to perform, in an environment where a Heating, Ventilation, or Air Conditioning (HVAC) unit is deployed, the steps of:
performing a testing phase, wherein the testing phase is configured to test an influence of the HVAC unit on a temperature of the environment, wherein the testing phase comprises:
performing at least one testing sequence, wherein a testing sequence of the at least one testing sequence comprises a sequence of two or more actions, wherein at least one action of the two or more actions comprises instructing the HVAC unit to change its target temperature, and
performing measurements of effects of the two or more actions on the temperature of the environment;
based on the testing phase, generating a temperature profile, wherein the temperature profile indicates the influence of the HVAC unit on the temperature of the environment; and
based on the temperature profile, generating a recommendation for a utilization of the HVAC unit.
